(19) United States
(12) Patent Application Publication
(10) Pub. No.: US 2006/0029714 A1
(43) Pub. Date: Feb. 9, 2006

(54) Direct lactic acid set fresh mozzarella cheese

(76) Inventors: Robert Fischer, Coronado, CA (US); Christophe Megevand, San Diego, CA (US)

Correspondence Address: B2 PATENT SERVICES, 406 ROSEMONT-RINGOES ROAD, STOCKTON, NJ, 08559, US

(21) Appl. No.: 10/914,713

(22) Filed: Aug. 9, 2004

(51) Int. Cl. A23C 19/00

(52) U.S. Cl. 426/582

(57) ABSTRACT

This invention relates to a process for making mozzarella cheese using lactic acid as the acidifying agent. Mozzarella cheese is currently acidified with either vinegar or citric acid. Either of these ingredients add undesirable taste. Mozzarella cheese made with vinegar or citric acid has a shelf life of about 25 days. In order to supply fresh mozzarella cheese to supermarkets across the country, a shelf life of at least 30 days is highly advantageous. Lactic acid provides the fresh mozzarella with a natural taste, smooth texture and significantly longer shelf life.

### BACKGROUND OF THE INVENTION

Typically, mozzarella cheese is made either by a “direct set” process, acidifying the milk with vinegar or citric acid and adding rennet (a coagulant) to the mix, or by culturing the milk through the addition of ferment (cheese cultures). Although their use in cheese production has been long standing, vinegar and citric acid are foreign to milk products. Both these materials mask the milk's natural flavor and add a bitter aftertaste when the cheese ages, even before the end of its shelf life. During the direct set process, the curds are stretched and washed with hot water. During processing, the cheese is kneaded to give the mozzarella a smooth, long texture which consumers associate with this type of cheese. The cheese is then packaged for freshness.

### SUMMARY OF THE INVENTION

There still exists a need for a means to produce fresh mozzarella cheese with good taste and correct texture. There additionally exists an ongoing need to increase the product's shelf life, in order to allow distribution of the product around the world with retention of quality during storage once the consumer purchases the cheese. By replacing the vinegar or citric acid with lactic acid, an acidifying agent commonly found in milk products, product taste and shelf life are dramatically improved. The smooth, creamy texture desired in fresh mozzarella cheese is obtained by a substantial reduction in the amount of rennet used in conjunction with the lactic acid. An added benefit of the reduced rennet is a decrease in cost of the final product. In fact, when the full amount of rennet was used, the lactic acid generated product had a more cohesive, undesirable texture.

Finally, a process for de-molding and hardening of the cheese using pasteurized temperature controlled water provides a skin that is tougher than traditional skins and is better able to prevent migration of packaging water into the cheese. This provides up to a 30% increase in the shelf-life of the fresh mozzarella cheese.

### DETAILED DESCRIPTION OF THE INVENTION

Direct set Mozzarella cheese is commonly made by acidifying milk products with vinegar (acetic acid) or citric acid in the presence of a coagulant (rennet). Both of these acids are foreign to milk products and provide the drawback of un-natural taste and moderate shelf life. This invention uses lactic acid, a gentle, natural milk acid, as the acidifying agent. In one embodiment of this invention the lactic acid is added at 0.15 to 0.20% based on the weight of milk. In another embodiment the lactic acid is added at 0.18% of the weight of milk.

By using lactic acid, the problem of un-natural or bitter taste is readily overcome. In addition, the level of rennet is reduced in order to maintain the desirable textural properties consumers associate with fresh mozzarella cheese. In another embodiment of this invention the level of rennet is reduced by 50% over what is used for mozzarella cheese made with vinegar. Yet another embodiment reduces the rennet by 50 to 70% of the original amount. (Typically, 210 to 240 mls of rennet per 2268 L of milk is used in the vinegar and citric acid mozzarella cheese process). For purposes of this application the rennet is present in the cheese at less than 100 mls in 2268 L of milk. In an embodiment of this invention the rennet is present in the cheese at between 60 and 105 ml in 2268 L of milk. An extended shelf life results from a tough skin, which prevents process water from getting into the cheese. The skin is the result of the use of lactic acid and rennet and is formed in the final phases of the process (demoulding and hardening steps) and is dependent on the time, temperature and pH of the cooling water. One requirement for the process is the use of pasteurized water rather than tap water. Additionally the pH of the hardening water is adjusted to slightly acidic pH. In one embodiment the pH of the hardening water is pH 6.0 to 7.5. In another embodiment the pH of the hardening water is 6.1 to 6.3.

As the cheese comes off the moulding table and into the hardening vat the pieces are referred to as balls, although they need not be round or cylindrical. The hardening step requires narrow control on the temperature of the water. The cheese is dropped from the mould at 57° C. into a hardening vat with pasteurized pH controlled water at 4 to 27° C. An embodiment of the initial hardening water temperature would be 21° C. As the cheese balls cool the hardening water is also cooled by passing it through a filter and heat exchanger system. As the cheese balls are processed through the hardening vat the temperature is lowered to a temperature of 4 to 10° C. over a period of about 20 to 60 minutes. An embodiment of this final water temperature range would be 7° C.

The following example is offered as a means to better illustrate the nature of the invention. It is not meant to limit the scope in any manner. One skilled in the art would recognize the important variables and be able to adapt the process and formulation to work in a wide variety of equipment and facilities without undue experimentation. All parts and percentages are based on an as-is weight unless otherwise stated.

### EXAMPLES

Process for Making Fresh Mozzarella Cheese

A mixing tank is cleaned, sterilized and filled with 2268 liters of pasteurized milk. The temperature of the milk should be about 7° C. (not higher than 10° C.). A lactic acid solution is prepared by adding 3.8 kg of 80% lactic acid to 5 times the volume of cold water. The lactic acid solution is added dropwise by gravity to the mixing tank of milk to obtain a pH of 5.85 to 5.95 to comply with the type of cheese being made (see Table 1 below). Steam heating is begun (in a double-jacket tank) and the pH is rechecked when the temperature reaches 24° C. Heating is continued until the tank temperature is about 35° C., then the steam is turned off and the tank continues to warm to 37° C. Double strength rennet (87.6 ml) is diluted with 10 times the volume of cold water, added to the tank and agitated for one minute. The agitator is then reversed and the tank mixed for an additional minute. The direction of the agitator is again reversed and slowed to a minimum speed and then moved to the front of the main hole. The tools are removed and replaced with a clean, sanitized cutting knife.

Setting time by definition is the time which the milk starts to coagulate. It usually takes 5 to 7 minutes after adding the rennet. The time is extremely critical and the cheese maker should monitor the curd continuously to find the exact right time. Curding time is usually 2 times the setting time, which means 10 to 14 minutes after addition of the rennet. Some indicating signs that the cheese is ready for cutting are no curd sticking to the sanitary glove, the curd can be cleanly cut, and a greenish-yellow liquid (whey) comes up from the curd. The cutting is started clockwise at minimum speed and gradually increased. When the curd is cut to ¾″×¾″ pieces the process is stopped.

The vat is then healed for 3 minutes. The agitator is run for 3 minutes and the vat is emptied onto the draining table.

The whey is pumped for 20 minutes out of the draining table, wherein the curd forms a block. The cheese is cut and turned into 15″×15″ slabs. Dry sea salt (29 kg) is added over 326 kg of curd and the slab is turned one more time. The total processing time of this step should not exceed 45 minutes.

The salted slab is cut into small pieces using a pasta cutter. The small pieces from the pasta cutter are then transferred and mixed in to a stretcher containing water heated to 79 to 83° C. The curd is then mechanically stretched and verified by hand for quality. When the curd is shiny and elastic, the gate to the moulder is opened. The stretch water should be clear and the total stretch time should be about 15 minutes. The cheese is moulded at 57° C. using a roller moulder. The product is pushed out of the roller moulder using pasteurized water at pH 6.2 and a temperature of 21° C. The quality of the skin is checked—it should be shiny and firm when rubbed.

Cheese balls are cooled gradually by floating the balls from a 21° C. zone to a 7° C. zone over a period of about 20 to 60 minutes (depending on the size, i.e. 20 minutes for perle 2.8 g, to 60 minutes for 453 g balls) while maintaining the pH of the cooled water at 6.2. The water is continuously cooled and filtered through a filter and heat exchanger.

The final mozzarella cheese product is packaged into cups from 142 g to 1400 g using a scale. The cups are then filled with pasteurized water adjusted to pH 6.2 and 7° C. and lightly salted.

TABLE 1
pH of various cheese types.

| Mozzarella Type (weight) | Acidity | pH |
|---|---|---|
| Perle (2.8 g) | 6.8 | 5.95 |
| Ciliegine (9.4 to 14.2 g) | 6.8 | 5.95 |
| Bocconcini (42 to 57 g) | 6.8 | 5.85-5.90 |
| Ovoline (113 g) | 6.8 | 5.85-5.95 |
| Ovoline (142 g) | 7.0 | 5.80 |
| Sofficella (227 g) | 7.0 | 5.80 |
| Logs (453-567 g) | 7.0 | 5.80 |

TABLE 2
Ingredients for fresh mozzarella cheese with various acidifiers

| | | | | | LACTIC | |
|---|---|---|---|---|---|---|
| Ingredient | VINEGAR | | CITRIC | | ACID | |
| Cow's milk | 2268 | liters | 2268 | liters | 2268 | liters |
| Acidifier | 12.7 | kg | 2.0 | kg citric | 3.8 | kg lactic |
| | | vinegar | | acid | | acid |
| Rennet | 212 | mls | 240 | mls | 87.6 | mls |
| Salt | 42.5 | kg | 42.5 | kg | 29 | kg |

| | | | |
|---|---|---|---|
| Texture | Good | Good | Excellent |
| Taste | Fair | Good | Excellent |

TABLE 3
Shelf life of fresh mozzarella cheese made with various acids.

| Acidifying Agent | Shelf Life | |
|---|---|---|
| Vinegar (acetic acid) | 21-24 | days |
| Citric Acid | 25-26 | days |
| Lactic Acid | 40 | days |

The data shown in this example illustrates the improvements in taste and texture of the process and formulation of this invention. Through the combined use of lactic acid, reduced amount of rennet and pasteurized, pH controlled water the shelf life can be significantly increased making it possible to offer the product for sale in a more generally acceptable manner.

What is claimed:

1. A cheese comprising milk, rennet and lactic acid.

2. The cheese of claim 1 wherein the rennet is present at less than 100 mls per 2268 liters of milk.

3. The cheese of claim 1 wherein the lactic acid is present at 0.18% of the weight of milk.

4. A process for making mozzarella cheese comprising,
acidifying milk with lactic acid,
adding rennet to the acidified milk,
setting and curding the milk proteins,
moulding and stretching the curd into cheese
demoulding and hardening the cheese with pasteurized water,
packaging the cheese in pasteurized water.

5. The process of claim 4 wherein the rennet is used at a level of 88 ml per 2268 liters of milk

6. The process of claim 4 wherein the lactic acid is used at 0.18% of the weight of milk.

7. The process of claim 4 wherein the pasteurized water is pH controlled.

8. The process of claim 7 wherein the pasteurized water is at pH 6.2.

9. The process of claim 8 wherein the pasteurized water is at 21° C.

10. The process of claim 9 wherein the temperature of the pasteurized water is lowered from 21° C. to 7° C. over 20 to 60 minutes (depending on the size of the balls) during the hardening step.

11. A cheese made by the process of claim 10.

12. A cheese made by the process of claim 10 wherein the cheese has a shelf life of greater than 30 days.

13. A process for making mozzarella cheese comprising,
acidifying 2268 L of milk with 0.18% by weight lactic acid,
adding between 60 and 105 mls of rennet to the acidified milk at a pH of 5.85 to 5.95,
setting and curding the milk proteins at 37° C.,
moulding and stretching the curd into cheese,
demoulding and hardening the cheese with pasteurized water at pH 6.2 and a temperature of 21° C. gradually cooled to 7° C. over a period of 20 to 60 minutes and,
packaging the cheese in pasteurized water at pH 6.2.

14. A mozzarella cheese made by the process of claim 13.

15. A mozzarella cheese made by the process of claim 13 wherein the cheese has a shelf-life of greater than 30 days.
